(19) United States
(12) Patent Application Publication
(10) Pub. No.: US 2025/0272337 A1
(43) Pub. Date: Aug. 28, 2025

(54) DENOISING SYSTEM AND METHOD

(71) Applicant: Demand Science Group, LLC, Danvers, MA (US)

(72) Inventor: Raghunandan Mishra, Danvers, MA (US)

(73) Assignee: Demand Science Group, LLC, Danvers, MA (US)

(21) Appl. No.: 19/060,039

(22) Filed: Feb. 21, 2025

(30) Foreign Application Priority Data
Feb. 28, 2024 (IN) 202441014497

(51) Int. Cl. G06F 16/9035; G06F 16/9032

(52) U.S. Cl. CPC G06F 16/9035; G06F 16/90332

(57) ABSTRACT

A system and method for denoising content are disclosed that using ensemble machine learning, natural language processing and artificial intelligence to remove noisy content from results. In one embodiment, the system and method for denoising content may be used to identify business to business (B2B) relevant content in a corpus of documents.

### PRIORITY CLAIMS/RELATED APPLICATIONS

This patent application claims priority under 35 USC 119 and is a continuation of Indian Provisional Ser. No. 20/244,1014497 filed Feb. 28, 2024, the entirety of which is incorporated herein by reference.

### FIELD

The disclosure relates to a system and method for denoising to distinguish high quality business content from general internet content using machine learning techniques.

### BACKGROUND

Business-to-business (B2B) sale is complex and depends on effective communication about the products or services offered by an organization to its potential customers or leads. Considering the vast market landscape across several industries, collection, and consumption of good quality content for B2B products and services poses a challenge. One way to source high-quality content is to identify and create a reliable list of websites (or publishers) that consistently produce relevant quality contents on the topics of interest. That is not enough, though because, due to proliferation of Internet and content publication, new publishers are constantly adding content that may be of importance and would be missed. Furthermore, the list of publishers may quickly get outdated and a lot of relevant content may be missed. On the other hand, without a deeper understanding of the publications, if the organization uses a broader strategy to collect open-source data from the Internet from a wide variety of websites, the quality and relevance of the content in a vast majority of cases could be a suspect. Thus, there is no shortage of content, but the real issue is that majority of the open-source documents are found to be non-relevant OR have higher component of noise that does not help the business professionals. This is a classical precision vs. recall trade-off, where the idea is to reduce errors while collecting high-quality content, while not leaving the important content out.

Note that the noise and quality in the context of B2B content syndication (in general) is determined by the context of the content. The implication is that although a piece of content may be high-quality for a certain type of consumer base (example, business-to-consumer (B2C) product or service), it may not be helpful for others. Hence, the definition of noise is important. At a high-level, noise arises in various ways including: short and jumbled text that does not make sense (literal noise); boiler-plate text that mean something but does not add value, and is not applicable for business users vis-à-vis citizen consumers (domain specific noise); over-reliance on keywords leading to irrelevant content (semantic noise); incorrect classification of content to the topic of interest (noise due to topical inconsistency); and finally, irrelevant for a particular persona but may be relevant to others (noise for a persona). It is practically impossible to manually identify and code the patterns behind the relevance, noise detection, and quality factors mentioned above due to the volume of content and the different types of ways in which noise occurs as described above.

Current systems rely largely on keyword-based content collection, distribution, or syndication to try to de-noise the content. Although this is the standard operating model, it has several lacunas and drawbacks that do not surface explicitly. The drawbacks become clear only during a post-analysis phase. There are at least two problematic issues with over-reliance on keywords.

The first problematic issue with over-reliance of keywords is related to categorization of content relevant for the B2B domain. A majority of the content on the Internet is oriented towards citizens and consumers rather than business and enterprises. Hence a keyword search is most likely fetching contents associated with consumer needs. In the B2B domain, this technique usually results in false positives that directly impacts the efficiency (target is not precise) of the overall system. Consider a campaign that is targeted towards businesses to sell vulnerability software. A keyword search associated with this product or business category produces vast majority of the content that is around malware, ransomware, and protection of devices for consumer grade hardware such as desktops, mobile phones, tablets, and other home automation system. While this is useful for most of the companies that are directly selling to the consumers, the sheer volume of content introduces challenges related to sorting and classifying content that are relevant to B2B versus B2C domain. In another real example, keyword like ambulatory care resulted in only 26% of the total content (834/2431) to be relevant in B2B.

The second problematic issue with over-reliance of keywords is the literal use of keywords for matching instead of getting into the context of the content. Although this does not necessarily look like a major issue, surprisingly, a good percentage of content fall under this bucket. To understand this better, consider another typical example anesthesiology. An article on lunar-gravity-parabolic-flight-experience has the following snippet of the text where the keyword is found:
Like many of the best opportunities in life, my “ticket” for a parabolic flight simulating lunar gravity arrived by serendipity. In February this year, I interviewed anesthesiology professor Alexander Chouker from Munich University in Germany about European research into hibernation for long-duration spaceflight . . . .

Clearly the article is about parabolic flights and the relationship with the keyword is anecdotal, incidental, and not significant. For this example keyword, only 25% of the total 2721 articles are found to be relevant.

To summarize, although keywords are a powerful mechanism to tag relevant content, the precision is lost in the process. The implication (as mentioned earlier) of this does not show up immediately. Buyer's Intent solution that uses keywords for targeting generates false positives that are not known during the lead or demand generation phase. However, when the target audience is contacted, the percentage that responds positively on a campaign is usually low. As an example, for a typical (top-of-the-funnel) campaign, the lead conversion is around 12.5%. The rest of the leads contacted do not show any interest in the product or services. The target audience may have browsed content that has the keyword but is relevant to consumer instead of companies (the first example), or the keyword was incidental, and it does not adequately represent the business category of the content (as seen in the second example).

There are several other limitations of existing systems that calls for re-design of the solution from scratch. Three issues are discussed below with some examples that illustrate the limitations of the existing systems. The first issue is reliability of the publication, if known, could help on relevance. This approach is very effective to ensure that the contents are sourced from known-valid publications that consistently produce high-quality and low-noise content, but there are two challenges. Firstly, how do we know which publication is reliable? And secondly, how can we maintain such a list? A quick answer to the first question would be to compile a popular (white) list of publishers. However, this is severely limited due to ‘literature bias’. Specifically, a lot of importance is given to few publications even though they may not be relevant in all areas, while it assigns no importance to unknown (but good) publications. The solution is mostly anecdotal and not driven by data or facts and produces very low recall value for the system. The second challenge (maintain the list) exaggerates the issues from the first one multi-fold.

The second issue is that a keyword is present but the document is for a completely different or irrelevant category. This is a subtle and tricky problem to identify and resolve. However, it can significantly enhance the relevance of information in the B2B context. Consider an example keyword like artificial intelligence. This is usually a catch-all term and several article on a variety of topics may mention it. For example, an article that describes the stock market trends of tech companies that provide AI-based solution is more relevant to users interested in market trends rather than AI technology. Thus, the context of the topic is very important to ensure lower noise and higher precision.

The third issue is that content may be relevant to one business user persona but may be noise for the other. This is usually the most likely scenario in the lead generation cycle. A finer nuanced approach is taken to predict how likely a business user (personas) will engage with the content for accurate targeting. In the B2C scenario, this is typically resolved by recommendation and personalization methods. For a B2B lead generation task, to ensure data security, privacy, and compliance, there is a limitation of the extent of knowledge one can have on individuals. Business personas do not keep track of user's personal information, habits, and activities. Only basic information such as job title is available.

Thus, it is desirable to provide a system and method that denoises content for B2B content and overcomes the above technical problems with the known systems and techniques and it is to this end that the disclosure is directed.

### BRIEF DESCRIPTION OF THE DRAWINGS

FIG. 1 illustrates an example of an implementation of a content denoising system that may be used for B2B content;

FIG. 2 illustrates a method for denoising B2B content;

FIG. 3 illustrated further details of the denoising process;

FIG. 4 illustrates an example of business relevance classification process;

FIG. 5 illustrates examples of the business relevance classification outcomes using the disclosed system and method;

FIG. 6 illustrates further details of the noise compared to business information generation process;

FIG. 7 illustrates further details of the keyword and category relevance information generation process;

FIG. 8 illustrates more details of the persona relevance process;

FIG. 9 illustrates more details of the guardrail (Level 0) process; and

FIG. 10 illustrates more details of the well formed content detecting (Level 1) process.

### DETAILED DESCRIPTION OF ONE OR MORE EMBODIMENTS

The disclosure is particularly applicable to denoising content for business to business (B2B) sales and lead generation and it is in this context that the disclosure will be described. It will be appreciated, however, that the system and method may be used to denoise other areas of content (more than just B2B) and may be implemented using various different types of content (in addition to the document examples described below) such as PDF files, audio, video and the like. Furthermore, the illustrative examples below talk about a query in the context of a search request/question for an entity that the system denoises as discussed below. However, the query can be anything: a keyword phrase, business category name, topic name, business theme or vertical, or even an offering description or document. The offering here means the description of a business solution, service, product, or platform provided by any company. Furthermore, a persona may be a job attribute that represent seniority, department, area of work, subject matter expertise, skills, job titles, or any custom-defined business persona of the audience.

The background above discloses various technical problems with known systems and techniques that, due to the technical problem, fail to remove the noise from B2B content. While the results of these technical problems are noisy data, it is the technical problems of the known techniques that result in the noisy data, such as B2B content. The below disclosed system and method overcomes these technical problems by provided a technical improvement over the known techniques.

The denoising system and method, in one or more embodiments, may include a set of heuristics of broad groups of syndromes that lead to non-relevance or noise within the content. Further, the system and method may use natural language processing and machine learning techniques to automatically identify the patterns in the content and flag those patterns. The system and method also may apply several cascading machine learning and natural language processing models (ensemble process) that filter down large volume of contents in form of a funnel. Each stage in the funnel executes gross-to-fine refinement strategies depending on the previous stage. The result is a ‘content noise evaluation’ system and method that not only removes irrelevant and low-quality content but in the process also determines relevance of content to publishers, keywords, business categories, topics, and companies and products mentioned within it.

The disclosed system and method may embody a formal statistical technique to create and maintain a (white) list of publishers at the topical level. Similarly, noise is reduced by creating and maintaining a (black) list of publishers that are found to be noisy more often. The disclosed system and method also may use existing set of ML and AI models to solve this issue rather than building one from scratch. The disclosed system and method also may have techniques that can associate content to personas to reduce the noise in the system and improve overall efficiency.

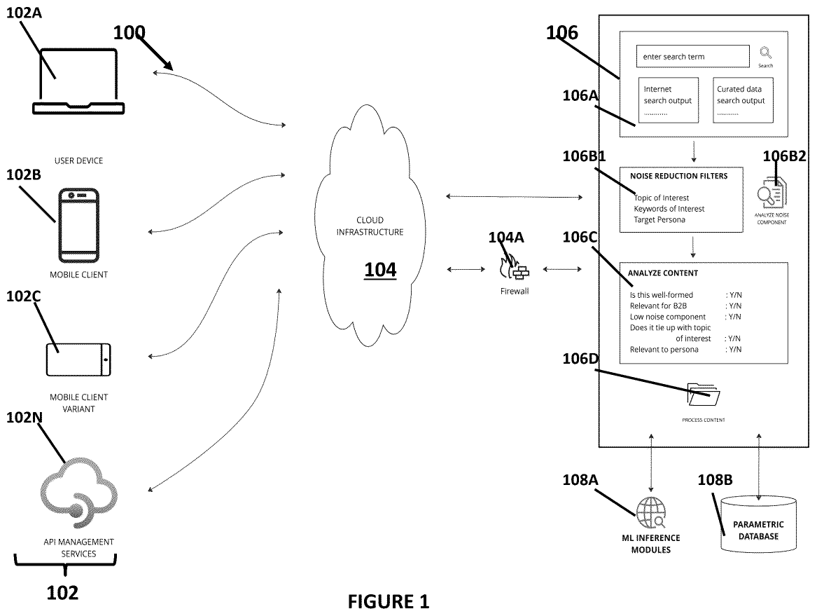

FIG. 1 illustrates an example of an implementation of a content denoising system 100 that may be used for B2B content. The system may have a plurality of devices with processors 102 that interact with the system and receive denoised content. For example, the devices with processors may be a laptop computer or tablet computer or desktop 102A, a smartphone device 102B, such as an Apple iPhone or Android OS based device, a mobile device 102C and/or an application programming interface (API) 102N that integrates with other systems. Each device 102 may have a processor, memory, a wired or wireless connectivity circuit and a display. Certain devices 102 may have a browser application or mobile application executed by the processor of the device 102 that sends data to the system and generates a user interface and displays data to the user based on data received from the system. Each device 102 may be coupled to a backend system 106 through a cloud infrastructure 104 using the wired or wireless connectivity circuit. Each device may used known secure or insecure connection and data protocols to communicate with the backend system 106. As shown in FIG. 1, the cloud infrastructure 104 may include a firewall 104A through which the device 102 communicates with the backend system 106.

The backend system 106 may include a sample use case of user interface (UI) that interacts with the machine learning modules 108A and parametric database 108B to produce the desired results (less noisy content results) that are returned to each device 102. The input to the system 106 is orchestrated through the cloud infrastructure layer 104 and the firewall 104A controls not only direct access of internal users but also provides a layer of protection to the system from external malicious agents. The backend system 106 may be implemented using a plurality of computing resources, such as cloud computing resources including processors, memory, etc, wherein one or more processors of the backend 106 may execute a plurality of lines of computer code/instructions and the one or more processors are configured to perform the operations and processes of the system as described in this document.

The backend 106 may include the user interface 106A (for searching, entering search terms, outputting search results and a curated search results output, a set of one or more noise reduction filters 106B1, and a noise component analysis module 108B2, a content analyzer 106C and data/content used by the process 106D. Each of these elements may be implemented in hardware or software with a plurality of lines of instructions executed by a processor.

In a typical use case, the system functions as follows. End-users are constantly each searching for relevant content for that user one-at-a-time using the user interface portion 106A. Simultaneously, a content syndication organization may be interested in analyzing content in bulk to curate high quality and relevant content. In both the scenarios, the search criteria would result in contents that are sourced from either the internet or from an in-house content database. Irrespective of the mechanism of search or the search output, as a next step, several gross and fine filters (filters 106B1) are setup and applied to each of the pieces of content (such as a plurality of documents in one example). Gross filters help identify noisy content in general and are applied to all the pieces of content. Fine filters such as business category, keywords, and personas are in user's control and are part of the user's input. Both the type of filters work in cascade (gross set of filters is followed by fine filters). Therefore, the system is not limited any particular type of content, topic, or end user persona.

The final outcome is a set of flags tagged to the content that can be accessed from outside the company's firewalls, or by the internal users from within the firewalls. Additionally, application programming interfaces (APIs) are used for integration with other systems through a rigourous authentication process. The implication is that certain system functions are available only within the company firewalls or through a subscription or license. External systems can be integrated with the API endpoints that are exposed via the cloud infrastruture 104.

As shown in FIG. 1, the search process is shown for illustration purposes since search represents one of the many possible use cases for the system. The search output passes through the analysis process 106C that applies both the gross and fine filters. The output of the analysis step 106C produces several noise related flags that answers the following questions:
Is the content safe for consumption?
Is the content well-formed?
Is the content relevant for B2B scenario?
Is the noise level of the content low, medium, or high?
Is the content relevant to the search criteria setup by the users?
Is the content relevant to the target persona?

These questions may be answered in a sequence as they reduce the noise from gross to fine criteria. To do so, the system interacts with the ML inference module 108A shown in the diagram. The ML modules 108A form the core engine and uses several natural language processing techniques, statistical and semantic analysis methods, and machine learning models to arrive at the outcome. For example, the safety with the guardrails may be performed and ensured by identifying the presence of harmful, hateful, obscene, and vulgar phrases in the content by cross-referencing it with an open source dictionary of such words; well-formed content could be determined by applying lexical rules that identify noisy patterns (like numbers, repeated words or phrases, etc.) in the text or a pre-trained language model may also be fine-tuned to detect such patterns and measure the noise ratio over words; supervised learning techniques work better to filter out content relevant to B2C scenarios (vs. B2B scenarios) and more generally to domain relevance filtering; the noise level of a well-formed text in the context of a business document may be handled by a combination of supervised and unsupervised techniques; a reverse information retrieval method (explained later) as an unsupervised method along with topic classification (a supervised method) mat be used to further identify the noise ratio; and the last two questions/scores may be addressed by a combination of supervised machine learning models that identify business entities, discover relationships between the entities, and score the strength of the relationships. Additionally, the system interacts with a parametric database 108B where optimum system configurations are stored and updated to manage data and model drifts.

Note that FIG. 1 shows the system with answers in a simple Yes/No format, but the output of the system is not limited to a binary classification. For example, each answer (even if shown as a binary classification) has a score and an explanation that can be reviewed by the end users (other systems or humans). These are not shown in the diagram due to space constraints but are described in detail later. The system 106 may have an export feature for bulk data analysis that can be stored to curate a high-quality content database that is useful for syndication, targeting, and re-targeting using campaigns.

In one of the important internal product use cases, there is need to understand B2B buyer's intent with high degree of accuracy and at scale. To achieve both accuracy and scale, the performance of the system 106 should be optimized for precision and recall metrics. In general, achieving scale in AI produces better recall ability, but it comes with a trade-off in precision. Higher volumes introduce noise to a higher degree and thus, filtering high quality content turns into a non-trivial task. Buyer's intent data in production is usually sourced from a third-party advertising platform that curates all the web pages browsed, read, and downloaded by the Internet users over a period. But such platform curates millions of page URLs consumed by the users per day. The purposes (or original search term) for the searches are never known. Thus, the users could be searching a product for personal consumption, browsing a news portal, or technical/social media forums, browsing products and company information for businesses, and so on. It is practically impossible to determine which content out of the millions is related to a B2B buying process. Deeper analysis of the content is one of the ways to probabilistically understand (through the nature of content) if it is of any relevance and is not noise as defined earlier. The problem statement now boils down to analyzing millions of page contents per day, and identifying high-quality documents that are relevant to B2B domain. Additionally, to reduce noise for lead generation task, the nuances of understanding business category, keywords, and the personas that are relevant for a content also becomes important. The gross and fine filtering techniques discussed below address the above two scenarios and helps to curate contents with higher degree of precision and recall.

In a second internal use case, a researcher working on customers campaigns may need to curate several high-quality supporting documents to identify the best target audience for the campaign. In such use case, the volume is not very high. However, there is a need to look at the general trend of content consumption (which is the first use case described above) and relate it back to campaign assets and target audience effectively. In doing so, the campaign manager uses all the relevance tag produced by the noise filtering system and compares the campaign asset effectiveness in that context. The ML inference module 108A shown in FIG. 1 is applied to the campaign assets as well and the results are augmented with the general trends from third-party content curation use case. Together, the campaign manager can reduce the noise in the top-of-the-funnel targeting.

The modules of the system 106 may be exposed to any B2B platform using APIs so that external users can invoke the processes of the system who having appropriate level of identity and access resolution. Each API acts as a microservice to the calling application that can be integrated with any external third-party system. In an external facing application, users that subscribe to the service are offered a Chrome extension that can be manually invoked on any web page. The extension API would call the content analysis engine and produce all the relevant flag along with insights such as business category, keywords, and personas. The business users do not need to spend their time reading enormous number of pages and can quickly glance through the output from the system to decide whether the content is relevant for them or not. Several other use cases that have touch points with business content can benefit from this system through a modification to the user interface depending on the use case objectives.

The system 100 shown in FIG. 1 may include machine learning aspects (ML inference modules 108A) that are developed and deployed. The system 100 may train ML/AI modules and the training modules hardware requirement may be performed, in one implementation, on a single graphics processing unit (GPU) instance with at least 16 GB RAM. An Amazon AWS instance (or its equivalent) may be used as they have a pre-configured environment with necessary TensorFlow and Pytorch libraries to train the models. The training also requires software that may include Python using Jupyter Notebook IDE as the programming language and also uses open-source libraries for model development, training, and testing the machine learning algorithms.

The machine learning modules may be deployed using machine learning inference scripts (108A) that are written in python and dockerized. The docker containers are deployed on the cloud 104 by exposing the API endpoints. Modules that require to be within the firewalls have different level of access controls and the access to APIs by external parties is controlled via API keys that are shared with the users or subscribers. In one implementation, the solution deployment may be by the application being tested internally on an AI playground platform before exposing any component to external facing applications. The user interface module 106A is built using React and JavaScript components that are integrated with the API endpoints. In some cases, the APIs are built and exposed in Golang programming language for efficiency gains but are largely built on Python.

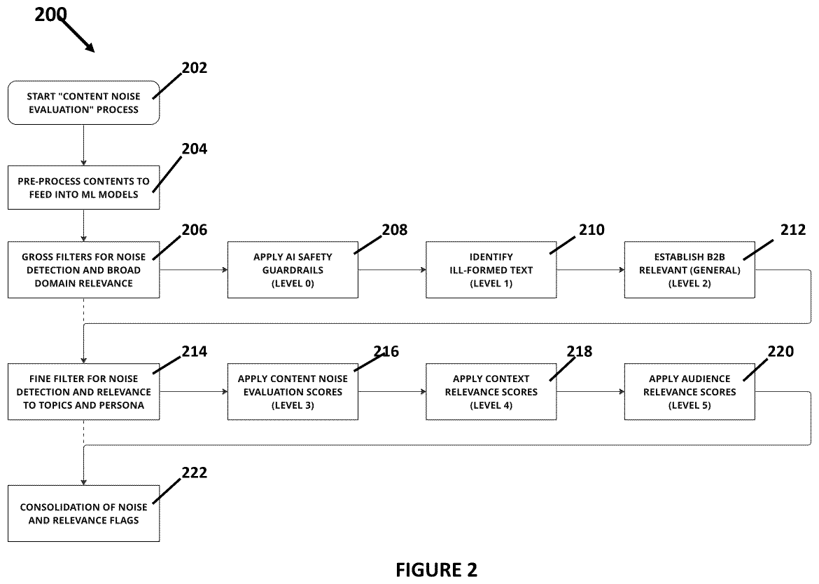

FIG. 2 illustrates a method 200 for denoising B2B content. The method 200 may be performed by the elements of system 100 shown in FIG. 1, but may also be implemented on other systems and architectures. Furthermore, although the system 100 is shown as using APIs by which third parties can access the system, the method shown in FIG. 2 may also be implemented on a closed computer system being operated and used solely by the owner of the system. The method 200 may include pre and post processing tasks to prepare the data and then have solutions that are stitched together into a novel process to distinguish between contents that are business relevant (by audience and topics) and others. The solution is sequential in nature as shown in FIG. 2.

The method 200 may use a combination of machine learning, natural language processing, and traditional software engineering techniques and components to denoise the content. There are four step broadly may include pre-processing of documents (204) to prepare the content as input for the components (including the ML models), gross filtering (206) that consists of several components aimed at filtering out a class of noise that are inherent to the content without any context (other than B2B needs) and content/documents flagged as noisy in this process (206) are discarded and do not flow downstream, fine filtering (214) that has several components that understands the nuances of the context of the content and documents that are flagged as noisy in this fine filtering process are conditionally discarded and a nuanced approach is taken in downstream applications, and organizing the output (222) into a structured set of flags and tags that can be used by downstream users and applications based on their own needs and objectives.

The method 200 starts with a content noise evaluation process (202) and initially performs the pre-processing of content process (204). This is a common part of the data pipeline that helps prepare the content(s) for machine learning. The contents in the input are treated as documents throughout the process flow. A document that has lesser than 25 words are already discarded irrespective of the potential value it may have. Hence, any full document that is conversational or is like a title is not considered as useful. This limitation helps to maintain strict principles for fine-tuning task-specific-models instead of having a generic-language-model. The document is segmented into sentences, and sentence into tokens. Note that punctuations are important and retained.

The pre-processed content is fed into the gross filter process (206) that filters for noise detection. The gross filtering may include three components/processes (208-212) that are built and grouped together. The first process applies an AI Safety Guardrails (level 0) (208) whose objective is to filter out problematic texts that may contain misleading information and/or harmful content. Note that this process is not the only process that removes such content. There are other layered processes (downstream process) that ensures a full solution. In this process 208, potential issues are identified and flagged based on indicators such as the use of specific terms, phrases, and sentiments. A dynamic framework is built that continuously evolves and adapts to the changing landscape of online content. Hard decision is made to either keep or discard the document.

The second process identifies Ill-formed Text (level 1) (210) whose objective is to ensure clarity, accuracy, and coherence in the curated documents while diligently filtering out ill-formed content. Surprisingly, a significant volume of content from the internet have malformed content. This step entails removal of grammatically incorrect or poorly structured documents, by evaluating the its overall readability. Natural language processing and machine learning algorithms (discussed below in more detail) may be used to identify and flag documents that deviate from established norms of well-structured and coherent writing. Again, hard decision is made to either keep or discard the document in this process.

The third process establish B2B Relevance—General (level 2) (212). Since the framework of this method is to provide a B2B solution, this filter ensures that any document that is related to B2C is discarded as irrelevant. In the B2C context, content focuses on engaging a broader audience, emphasizing emotional appeal, relatability, and ease of comprehension. Conversely, B2B document prioritizes depth, detail, and expertise. Professionals audience usually seek data-driven and comprehensive content that helps them take critical business decisions. A transformer based supervised machine learning model may be used to identify such patterns in documents. The model takes a slightly softer approach to look at the B2B relevance score to help with keep/discard decision.

The results from the gross filtering processes (206-212) may be fed into a fine filter process (214) for noise detection and relevance to topics and persona. The fine filtering 214 may likewise include three components that are built and grouped together. A first process applies Content Noise Evaluation Scores (level 3) (216) that uses an AI model developed for the system and method. The AI model is designed to analyze ‘content noise evaluation’ that quantifies ‘noise’ in any piece of content. It does so by measuring the relevance and amount of information in the content in relation to a predefined topic of interest. This is achieved through a sophisticated algorithm (and not merely through keyword-matching exercise), that assigns a probabilistic score, indicating the degree to which the content deviates from the core subject matter. Lower noise score indicates high relevance and amount of information in the content, while a higher score suggests the presence of significant noise or irrelevant information. The output of the model is not binary (keep/discard). It is a score that requires statistical analysis based on human evaluation of the scores to determine the right threshold for the decision making.

A second process applies Context Relevance Scores (level 4) (218) and is an extension of the content noise evaluation system. In this process, the noise in the document is calculated based on the context which are primarily derived by keywords and business categories associated with the document. Keywords are direct mention of terms or phrases in the document while business categories underline the concept of the document and is not necessarily mentioned directly. The contextual relevance of document is not independently deduced by the presence of certain terms. Instead, the importance of keywords in the context of business categories is determined first. It is the combination of the keywords and the underlying concept that helps to calculate the contextual relevance score. This produces a nuanced and comprehensive understanding of the document. Since, this produces only the contextual noise, the document is not discarded at this step. Only the scores, the keywords, and the business categories are tagged to the document. Downstream users and application can use the information as a decision aid.

The third process applies Audience Relevance Scores (level 5) (220) in which this process understands, categorizes, and personalizes content specific to B2B personas using a combination of several techniques. It uses natural language processing to get a sense of industries, skills, job functions, and job seniority that may be interested in the content. The persona model analyzes the above indicators and predict which persona will resonate more with the content, enabling the creation or curation of highly targeted and relevant content based on target audience.

Once the gross and fine filtering processes are performed, the method may consolidate the noise and relevance flags (222). This is a common part of the data pipeline that consolidates and distributes all the relevance flags, category-keyword tags, and audience metadata along with the scores. It makes recommendation based on statistical analysis. The gross filters (206-212) provide a keep/discard binary decision, while the fine filters (214-220) provide additional context and flags for the downstream application to understand and use the intelligence to achieve its own objectives.

### Examples of Noise Reduction Stages

To better understand the processes in FIG. 2 and demonstrate the issues and limitations (technical problems) overcome by the technical solution embodied in the method 200, some simple questions are raised and data driven analysis is conducted to answer them. A corpus of few million articles is used as baseline for the analysis and the corpus was obtained from an advertising platform that tracks users' content (page URL) consumption.

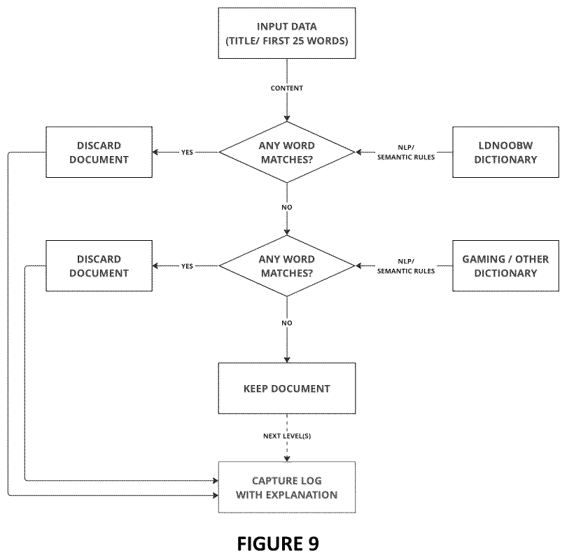

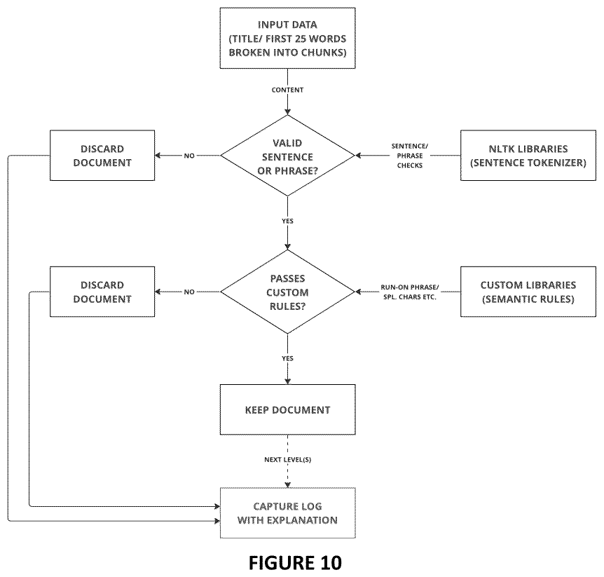

The Level 0 and 1 filter processes (208, 210) considers the document content without any context. In other words, these processes look for problematic patterns within the document and hence can be applied to any use case (content marketing, B2B, B2C, document curation etc.). These Level 0 and 1 filter processes are described in detail below with reference to FIGS. 9-10.

In an example of the B2B vs. B2C articles (level 2) filtering process (212), the questioned answered is “why doesn't a keyword search on the internet article work for B2B targeting?” by considering the keyword ambulatory care. A search for articles that has mention of this keyword produces several thousand (3265) articles. The issues with these articles are: 1) several articles describing the general meaning of the word mentions this keyword with the most prominent being English and language translation dictionaries. There are many other document examples in the legal domain that uses this keyword (e.g., legal-principles-flashcard (see quizlet.com/538515493/chapter-3-legal-principles-flash-cards/) or an article on can-you-get-a-gun (See optimistminds.com/can-you-get-a-gun-if-you-have-anxiety/). All the articles have the keywords but none of them are relevant to B2B targeting or in the domain; and 2) The method 200 uses gross noise reduction technique to weed out 2431 such articles and preserve only 834 high quality relevant articles from the feed. That's just 26% of the total articles analyzed. An important observation is made around keywords that are not domain specific and are part of the consumer lingo. Articles having such keyword tend to be noisy in the B2B context (although they may be perfectly acceptable in the B2C context).

In an example of high noise component (level 3) process (216), the question answered is “does B2B looking article have high levels of noise in it?”. Consider the following three texts that appear right on the top of a page URL content:
Like the site? Help support it and become a subscriber or join the Discord Server! Are you of legal age to view the content in your country?
By continuing to browse our site, you agree to our Cookie Policy. For information visit here.
Copy file link to clipboard and Save file to My Files. By enabling the Turbo Downloader Beta, you are agreeing to use software that hasn't been fully tested.

Although these look like content related to some business application due to usage of words such as server, keywords, turbo downloader etc., they do not add much value to the user's research. Note that the articles by themselves are not noisy but these are transactional in nature. A user specifically looking to transact on the webpage may find this useful but in general, it does not help B2B researchers. Hence, these are tagged as H, H, M respectively, to indicate high (H) and medium (M) noise levels in the document.

In an example of contextual keywords and categories (level 4) process (218), the question answered is “can keywords substitute the concept behind the article?” In this example, the keyword anesthesiology may be used. Only 25% of the total of 2721 articles are found to be relevant for a B2B scenario i.e., passes level 3. But a closer look at these articles shows other nuanced problems including 1) consider an article on lunar-gravity-parabolic-flight-experience. A snippet of the text where the keyword is found is “Like many of the best opportunities in life, my “ticket” for a parabolic flight simulating lunar gravity arrived by serendipity. In February this year, I interviewed anesthesiology professor Alexander Chouker from Munich University in Germany about European research into hibernation for long-duration spaceflight . . . ”. Clearly the article is about parabolic flights and the relationship with the keyword is anecdotal, incidental, and not significant; and 2) other examples of articles that do not show up under Healthcare related topics but uses this keyword are articles with the following titles: pet-owners-warned-not-to-dress-dogs, mount-everest-expedition, you're-charging-how-much.

In another example of a business category complementing keywords (level 4) (filter process 218), the question answered is “how can we understand the category of discussion at scale? what is its relationship with keywords?”. To illustrate the importance of fine-grained classification, consider the keyword clinical informatics. The keyword may be used in several context and the topic of interest for each differs. Keywords in the context of the category broadens the search horizon as shown below where the keywords are mentioned while the associated topic shows how accurate targeting works:
Category Healthcare Informatics e.g., educational-site, mount-sinai-accenture-partnership, bartleby-essay, . . .
Category eClinic Works e.g., clinical-network-solution, about-soflink, epic-on-healthcare-accessibility, . . .
Category Healthcare AI e.g., on-Nebraska-clinic, epic-to-integrate-gpt, alzheimers-research, on-uw-health-an-ai, . . .
Category Healthcare IT Solutions e.g., data-driven-org-by-forbes, privia-health-offering, cmo-announcement, . . .

The system and method uses existing topic classification and keyword extraction models in a novel way to understand the core idea behind the article and the relevance of keywords. This unique approach augments the context of the topic being discussed to further differentiate business value of the articles.

In an example of relevance to audience (level 5) process (220), the method gets into the relevance by target audience by using personas as a means and asks, “How do we determine who is the right audience for a content?”. The process 220 addresses this by analyzing the content in a different dimension to determine the relevance of articles to variety of audience. For example, for the keyword electronic medical record (emr), one can see how different contents suits different audience needs.
Persona with Finance function e.g., accounting-error-in-Elmhurst, updated-billing-guide, revenue-cycle-mgmt., . . .
Persona with Administrative function e.g., ethics-of-medical-assisting, medical-assistants, . . .
Persona with Information Technology interest e.g., forbes-biobanking, ai-repurposing-medication, digital-health-companies, . . .
Person having Legal function e.g., law-review, security-issue-at-hospital, data-breach-at-Queensway, patient-data-exposure, . . .
Persona with Recruitment function e.g., cardiothoracic-salary, group-inc-usgi-salary, icu-salary, . . .

As discussed below in more detail, the system and method implements an audience matching algorithm that can accurately recommend the target audience for a content using inherent properties of the persona such as industry, cross-sector utility, skills, job functions and seniority level.

The system and method are described to analyze content from the internet and in-house curated content. However, there are several other applications and use cases that can effectively utilize the system and method including the analysis of content generation as a part of search engine optimization (SEO), the analysis of content distribution as a part of campaign for demand generation or curation and distribution of newsletters for reaching out to business audience.

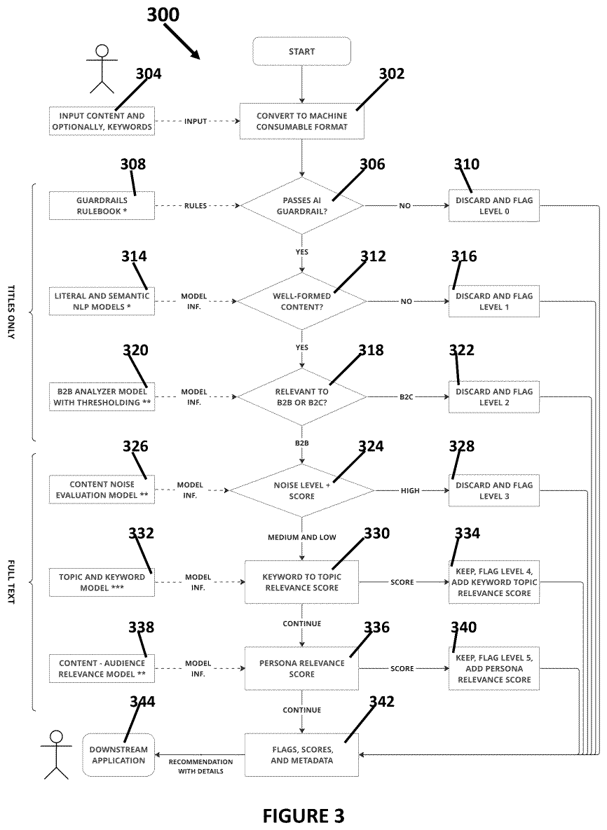

FIG. 3 illustrated further details of the denoising process in which several components make up the noise evaluation and are shown in FIG. 3. FIG. 3 describes a sequence of events to analyze business documents and create a robust, flexible noise reduction mechanism. The left-hand-side and middle portion of the flow chart shows the models and the sequence of applications of the process, while the right-hand-side depicts how the outcome of each step is treated. A notation of ‘level’ is used for reiterate the sequential nature of the workflow. As the document pasess through level each level (starting from 0), it is either kept for next level of analysis, or discarded with no further action, or is scored for final consolidation of noise components in the document. The stricter or the gross criteria in initial levels (0, 1, 2) uses document ‘title’ to recommend to either keep or discard the document, while the finer criteria in later levels (3, 4, 5) uses document ‘full text’ to determine noise level score for document. Further details are provided below about how different documents behave at each level and their final outcome.

### Pre-Processing (204, 302)

The method 300 may receive input (304) that is one or more pieces of content and optionally keywords and convert the content onto a machine consumable format (302) which may be known as input pre-processing and follows common data pre-processing patterns for various machine learning models that are part of the system and method. The input for all the models is the text or (content) followed by set of parameters that differ by each level. The raw input from source may have different format such as just a URL (instead of text), a JSON structure (with text being part of the key-value), or any format. The pre-processing 302 extracts the text that is needed for analysis along with all the punctuations. Any html tags or other encoding errors are handled to produce clean readable text. This is then broken down into tokens (roughly equivalent but not same as word), sentences, paragraphs, and documents. Next, the language of the text is determined through a language detection model to ensure compatibility with all the downstream models.

### AI Guardrails (208, 306)

Once the content is pre-processed, it may be fed into an AI guardrails process 306 (shown as process 208 in FIG. 2) that receives guardrail rulebook with rules (308) as an input. Guardrail in the noise evaluation (or any automation) system helps to adhere to the principles of do no harm when interacting with real-world-data. A helpful model tries to do a task without evaluating if the input is worth evaluating i.e., if it is harmful, or not. Hence, helpfulness and harmfulness are a tradeoff. A helpful model tends to increase harm, while a harmless model tends to ignore or discard even slightly suspicious input making it less helpful. Keeping this principle, a guardrail is established that ensures a model does not overlook problematic contents. Although some form of the guardrail is applied throughout the solution, it is more directly and prominently applied in level 0. A popular acronym LDNOOBW (list of dirty, naughty, obscene, and other bad words) is used to identify the first level of noisy documents that have profanities. Several dictionaries are published that lists such terms in different languages. In this level (level 0), one of the principles of the rulebook is “does the content contain any word or term that is part of the LDNOOBW dictionary?”. Several other rules are created to handle other types of ineligible content. For example, the volume of content generated on gaming software (usage, installation, review etc.) is significantly high. Such articles invariably trickle down in any content extraction engine and adds to the noise. The guardrail answers the following question in these cases, “does the content reflect terms that refer to an online gaming platform or character?” Gaming related contents are flagged as before. These are just illustrative guardrail, and a full rulebook is not described here. One of the key benefits for such an approach is it that the output of the system is easy to read, explain, and understand, making the AI system intuitive and simple. Further details of this Level 0 process are shown in FIG. 9 that is described below.

The guardrail process 306 may discard and flag Level 0 (310). Several examples of the AI guardrail process 396 results are:

Title: Does your country regulation allow
you to view this porno content . . .

| Level | Outcome | Explanation |
|---|---|---|
| 0 | Discard | Violates Guardrails {presence of term: porno}. |

Title: M-Class (W163) Produced 1998-2005: ML 230, ML
320, CDI Jan. 27, 2013, Newbie Thread Starter . . .

| Level | Outcome | Explanation |
|---|---|---|
| 0 | Keep | Does not violate any guardrails. |

### Well Formed Content Process (210, 312)

The pieces of content that pass the AI guardrails is input to a well formed content assessment process 312 (process 210 in FIG. 2) that receives (314) model inferences from literal and semantic natural language processing (NLP) models. This level 1 of noise evaluation looks for content that are not well formed. Although this looks like an obvious but insignificant problem, when analyzing content from Internet it is found that at high volume, vast number of documents are often discarded at this level. There may be several reasons why a document falls under this category. One of the root causes for ill-formed text is the format difference between the published data and the preprocessing process 302 described above. In particular, publications describing the products are laden with images, tables, blobs, and other such presentation formats along with text. Due to the lack of a single (sophisticated) library that can identify different data forms or formats, and separate them out as different elements, the extraction process ends up preprocessing all the elements into a full text data that is mingled with noise. Although such documents may contain relevant information, the details are not enough for the downstream models to classify it into business categories and topics, or explain the classification adequately.

Semantic rules are implemented in this level to identify if the content is well formed or not. The lexical rules for a language are well known and easily implemented using the well-known and publicly available natural language toolkit (NLTK) library. Additionally, several practical issues are identified at this level such as: repeating words, or run-on phrases, or garbled and fragmented sentence, or special characters and emojis translated into characters. Note that sometimes several sentences are extracted from the source without any punctuation due to limitation in the extraction process that could lead to conclusions that the document is not well-formed (run-on phrases). This is avoided by implementing libraries that reconstruct legitimate sentences from long fragments. Finally, based on quantitative analysis (percentage of ill-formed text and sentences), the document is either considered as noisy or not, and discarded or kept, respectively (316). Further details of this Level 1 process is shown in FIG. 10 and described below in more detail.

Example inputs (using at least one piece of content kept at Level 0) and results of the well formed content analysis (312) are:

Title: M-Class (W163) Produced 1998-2005: ML 230, ML
320, CDI Jan. 27, 2013, Newbie Thread Starter . . .

| Level | Outcome | Explanation |
|---|---|---|
| 0 | Keep | Does not violate any guardrails. |
| 1 | Discard | Ill-formed text {jumbled phrases}. |

Title: Most of the people tend to buy Azure Tower Level 3 -
Gamer Walkthroughs online it's much easier and quicker . . .

| Level | Outcome | Explanation |
|---|---|---|
| 0 | Keep | Does not violate any guardrails. |
| 1 | Keep | Is well-formed. |

### B2B Relevance Filter Process (212, 318)

The pieces of content that are well-formed may be fed into a B2B relevance filter 318 (process 212 in FIG. 2) that receives model inferences from a B2B analyzer model with thresholding (320). This level 2 of the noise evaluation process is an important process that classifies documents based on its relevance for business users. Publications produce several types of contents daily for different audiences. Not surprisingly, most of them are not business content but are related to sections such as politics, sports, entertainment, lifestyle, and other popular culture themes. An efficient system that recognizes the relevance of an article to business and associated sector is critical for noise evaluation.

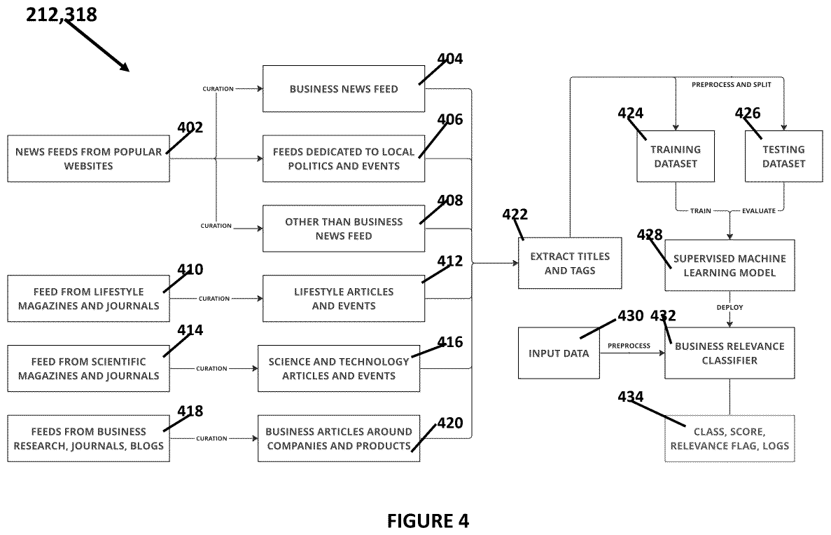

Further details of this process 318 as shown in FIG. 4 that illustrates an example of the business relevance classification process 318. FIG. 4 shows the process for training and evaluating machine learning models to identify business contents. Although this level is tagged as gross filtering, the solution uses sophisticated machine learning model along with the guardrail and lexical approach discussed earlier.

Training Data Collection: As seen in the figure, irrespective of the method of training, an important component of this process is to identify the classes for the machine learning task (processes 402-422). News feeds 402 from popular sites are an important source of content as they produce both business relevant and non-relevant articles. Typically, this source produces feeds that are related to ‘politics’, ‘sports’, ‘entertainment’, ‘lifestyle’, and credible ‘business news’ sections (404-408). A data ingestion process tracks the feeds through RSS subscriptions and automatically labels the articles into one of the classes above.

Next, the documents are sourced from reliable lifestyle magazines and journals (410) to curate articles and events related to lifestyle (412) such as ‘health’, ‘wellness’, ‘travel’, and other topics. It is important to note that lifestyle articles are targeted towards consumers in general but may also be relevant to business and is usually a grey area. For example, an article on diabetes awareness for citizens may be of interest for pharmaceutical companies as well to understand the trends and industry outlook and place relevant advertisement. The third important source comes from scientific magazines and journals (414) that publishes ‘science and technology’ articles relevant for technology businesses (416). Finally, feeds from business research journals, blogs, and analyst reports (418) are curated and produce high quality ‘business’ articles that is directly relevant to B2B scenarios (420).

All the article feeds are curated and tagged automatically. Articles that are tagged into ‘business news’, ‘lifestyle’, and certain topics of ‘science and technology’ are manually reviewed for accuracy and confusion in tagging. The daily volume of articles produced with these feeds require (computationally) highly performant machine learning infrastructure. To address this, the training is done only on the ‘title’ of an article instead of ‘full articles’ or ‘abstracts’ (422). It is found that the best accuracy is obtained when a model is trained on ‘titles’ as addition of more words and sentences introduces noise in the data that has diminishing returns for purpose of classification. If the input does not contain an explicit title, the first sentence or up to first 12 words of the articles are extracted and used in lieu of title. An optional input to the model is the full URL of the page that is processed to extract the title of the article.

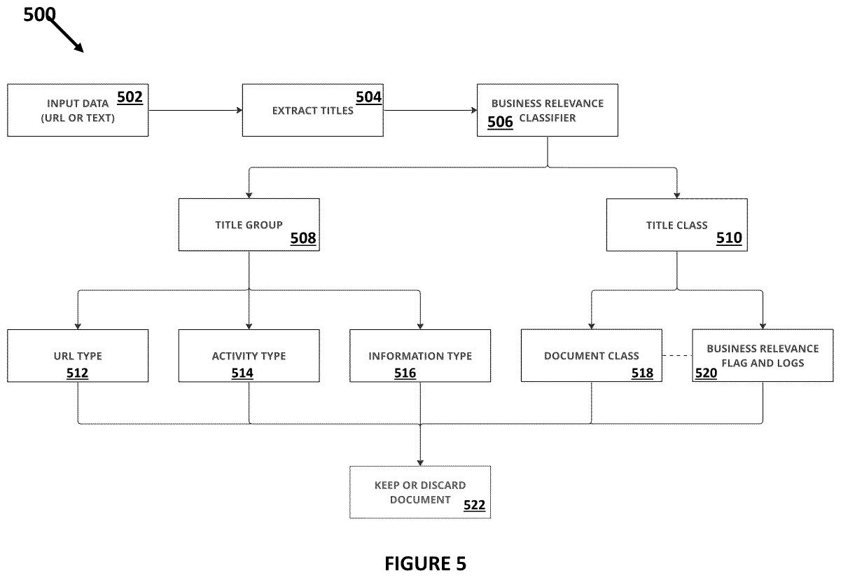

The classification system has two parts as shown in FIG. 5. The first part organizes an article broadly into different groupings such as ‘URL type’, ‘activity type’, and ‘information type’ (512-516). The second part directly classifies an article using machine learning models. The training data is curated as described above.

Group the Titles: A title is grouped into three different types using a semantic unsupervised algorithm that can be trained in supervised manner with labeled dataset. The model is composed of two components. First, a URL parser that uses Regex patterns to segment URL (if available) into protocol, domain, subdomain, path, parameter etc., and derive other details like page title, publisher, publication name, presence of acronyms etc. Second, a supervised classifier 428 that considers a title as a query (or question) that the user is searching on. The model (BERT for sequence classification) is trained on a sample dataset ORCAS-I-18M which contains click-based dataset of web queries. A pipeline is built for easy fine-tuning of the model for sequence classification, such as phrases and search queries.

The model components (as shown in FIG. 5) produce three groups of title type in the output. The three indicators (shown below) together provide rich insight on the type of content within the article and its business relevance. The three indicators are: URL Type (512): [site, subsite, music, picture, text, application, service, html, form, file], if full URL of the page is available; Activity Type (514): [visiting, reading, downloading, executing, contacting]; and Information Type (516): [navigational, transactional, informational].

Classify the Titles: Several techniques may be used to classify documents based on titles or title extracts into document classes (510). One of the methods is to use supervised learning model if good quality labeled data is available for training. The end goal as seen in FIG. 4, is to output the most likely class given a document (title). Additional components are added as layers in the models to go beyond just a classification and recommend via., decision aid to indicate whether to keep or discard the document. Sometimes, an explainer log is provided to explain why the decision was made.

Determine Document Class and score (434): Based on the title, the document is classified into one these classes: [news, politics, entertainment, business news, lifestyle, science and technology, business]. The model publishes top two classes along with the score for each title to help with decision making and explanation.

Determine Business Relevance Flag (432, 520): The top two classes from model inference are analyzed further to recommend a (B2B) relevance flag. The flag is derived based on statistical analysis of the accuracies of the model at class level. Out of all the classes, four classes [business news, lifestyle, science and technology, and business] contribute positively to business relevance. Out of the four, the first two are usually borderline in the sense they may be targeted to either consumers and citizens, or business professionals, or sometimes both. Thresholds are applied on the individual probabilities of the top two classes to determine the contribution of the classes for business relevance flag. Like the guardrails approach, a few confusing titles are weeded out using the rulebook method with a different dictionary for example, gaming and related words.

Publish the outcome: An explainer log is maintained when a simple best-class-wins approach fails. Some of the scenarios below illustrates how this works. The outcome is the decision to either keep or discard the document. An example of the process with inputs and outputs are shown below. In some cases that inputs were kept in the Level 0 and 1 process above.

Title: Most people tend to buy Azure Tower Level 3 - Gamer
Walkthroughs online it's much easier and quicker . . .

| Level | Outcome | Explanation |
|---|---|---|
| 0 | Keep | Does not violate any guardrails. |
| 1 | Keep | Is well-formed. |
| 2 | Discard | Is not relevant {Highest score is business (0.95) as |
| | | it looks like a Microsoft article, but the key term |
| | | ‘gamer’ indicates otherwise}. |

Title: Bed Bath & Beyond Employee Quits
In Style, Blasts Boss On Price Tag

| Level | Outcome | Explanation |
|---|---|---|
| 0 | Keep | Does not violate any guardrails. |
| 1 | Keep | Is well-formed. |
| 2 | Discard | Is not relevant {Top recommended class is lifestyle |
| | | (0.98) but second one business news (0.01) has |
| | | very low probability}. |

Title: By continuing to browse our site, you agree to
our Cookie Policy. For information visit here . . .

| Level | Outcome | Explanation |
|---|---|---|
| 0 | Keep | Does not violate any guardrails. |
| 1 | Keep | Is well-formed |
| 2 | Keep | Is relevant {Top recommended class is lifestyle |
| | | (0.40) and second one is business news (0.37); |
| | | both have probability greater than cut-off}. |

To summarize, the classification system level 2 uses several gross filters to provide a robust platform to analyze large volume of content, examine their titles, and decide to keep or discard them. The gross filter uses a combination of machine learning, natural language processing, guardrail rulebooks, and other lexical techniques. The output is a set of documents that are found to be relevant to B2B sector.

The next set of filtering level 3, 4, 5, are fed with full text of the contents (instead of just the titles). In these levels, the contents that qualify from previous levels are further evaluated for finer relevance. They determine noise in the context of a business concepts and the persona consuming the same. As explained before, the next set of levels do not necessarily discard content but tags the relevance of content for the industry, enterprise, business, and professionals.

### Noise Level and Scoring Process (216, 324)

Returning to FIG. 3, the output from the B2B relevance filter process may be fed into a noise level and score evaluation process (process 216 in FIG. 2) 324 that uses a novel content noise and evaluation model (326) inferences. The level 3 achieves dual objectives on the B2B qualified documents. First, it identifies the component of text that can be considered as noise vis-à-vis the business information. Simultaneously, it assigns the most relevant business concept or topic described in the content. Level 3 defines the task as information extraction and the approach may be considered as a reversal of ‘information retrieval’ algorithm. It acts like a sophisticated guardrail that goes beyond rulebooks and keywords. It uses the definitions, positive keywords, and negative keywords to define several relevant B2B concepts and compares how much of the concept information is present in the document. Once the business information is quantified, noise component is calculated using its additive inverse.

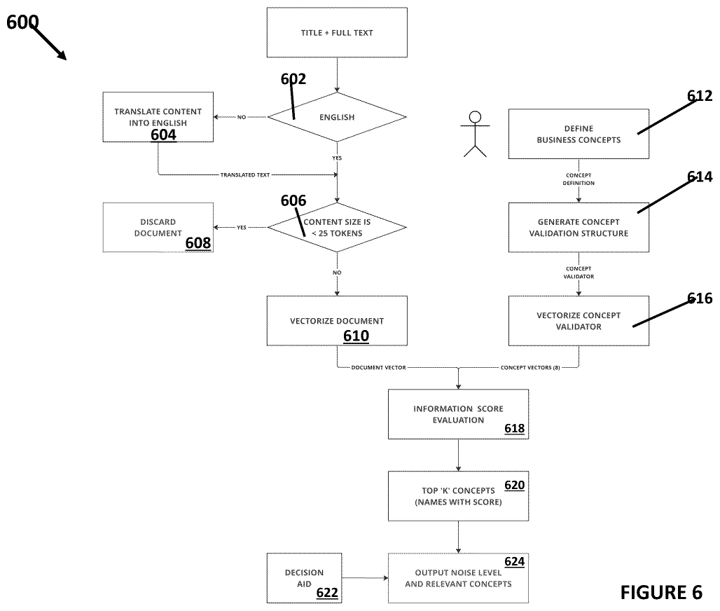

The technique uses semi-supervised machine learning method. An unsupervised model quantifies noise (or information) in the input document, while labeled ground truth and statistical analysis is used for final recommendation (keep or discard). This technique is found to be efficient because (i) it does not require a lot of labeled document for ground truth, and (ii) it works well when the model is expected to output multiple answers. However, the approach can also be built using supervised learning algorithms as well. The details of the process are shown in FIG. 6 and described below.

Basic Checks: This is the first level where full document content is exposed to the system. Therefore, a couple of basic checks are done. Firstly, many open-source models or libraries do not support (or are not efficient) in prediction in language other than English. Hence, an optional step is added to detect the predominant language of the document. If it is found to be other than English then the document passes through a translation module to get the contents in English language (processes 602, 604 in FIG. 6).

Next, if the total size of the content as determined by the number of words and tokens is found to be less than 25 (606), the document is discarded (608). This is done for practical purpose and is optional. Shorter texts tend to be informal and do not necessarily convey business concept fully. This may lead to incorrect tagging of topics and concepts to shorter documents reducing the overall accuracy of the system. The system is primed for medium-to-long documents with no upper limit on the document size. However, the system can be trained to include shorter documents as well removing this limitation. There is no theoretical challenge in including shorter documents for analysis.

Develop Business Concepts: Level 3 noise detection as shown in FIG. 6 is not straightforward because documents that seem to have business titles may have contents that are incoherent, ambiguous, and sometimes may not convey any meaning. This is observed in almost 30% of the documents that passes through levels 0, 1 and 2. The number is significant and hence the following solution is adopted. Thus, in the process 600, business topics or concepts are defined (612) in advance either manually, or through generative AI systems or using any other model. The creation of the concepts in form of members of a taxonomy itself is a non-trivial task and requires expert oversight if a generative model is used instead of manual curation. Once the concepts are in place, several metadata are generated and associated with it, some of which include: 1) Name of the concept in a hierarchical format with parent-child relationships; 2) Definition describing what is and what is not included in the scope of concept; 3) Typical keywords associated with the concepts; and 4) One or more sample documents that describe the concept with examples. An example of a concept is shown below:
Concept—Sales Development Representative (SDR) as a Service
Alternate Name—SDR as-a-Service
Hierarchy—Business>>Sales>>
Definition—SDR-as-a-Service refers to outsourcing SDR work to sales development representatives who can handle lead generation, qualification, and nurturing. It is a business model where companies hire external agencies or vendors to handle their SDR activities. SDR-as-a-Service allows companies to focus on their core business functions while leveraging the expertise of specialized SDR teams.
What it is (inclusions)—It includes appointment setting and/or prospecting as a managed service outsourced to a third-party service provider. The service providers typically offer a range of services including lead generation, prospecting, appointment setting, and qualification.
What it is not (exclusions)—Closing the sales, strategic development, customer relationship management, customized sales pitch, and several other aspects of lead generation are typically not included in this service.
Keywords—‘Outbound sales outsourcing’, ‘Sales Development Representative outsourcing’, ‘SDR outsourcing’, ‘External SDR service’, ‘SDR agency’.
Sample Document (Example)—In today's competitive market, businesses are constantly seeking innovative solutions to drive revenue growth and expand their customer base. One such solution gaining popularity is outsourcing Sales Development Representatives (SDRs) as a Service. This document highlights the top three SDR-as-a-Service offerings available in the market today, providing businesses with efficient and effective ways to streamline their sales processes and accelerate revenue generation . . .
The concept may be stored in a business (data) library in different formats to support the requirement of different applications.

Generate Concept Validation Structure (614): A concept/topic validation structure is maintained as a part of technical solution or library. Eight different validations form the basis for determining how much of the document being examined comply with the concept definition. Continuing the example concept above, a string format of the validation library may look like below, but the actual format may be stored in JSON.

```
{
  concept_name: “Does the document discuss the business concept {name}?”
  concept_alt_name: “Alternatively, does the document discuss concept {alt}?”
  parent_name: “Is the document related to {name} under domain {parent}?”
  concept_meaning: “Is the document or parts of it similar to the {name}?”
    pos_tokens: “What percentage of document tokens describe {inclusions}?”
    neg_tokens: “What percentage of document tokens describe {exclusions}?”
  keywords: “Are there any phrases or sentences that uses {keywords}”
  sample_doc: “How similar is the document to the {sample document}?”
}
```

Vectorize Concept Definitions, and Documents (610, 616): In this process, an embedding model is used to vectorize both the concept definition (616) and the document (610). It is a standard technique to use the two vectors to determine the similarities based on measures such as cosine function. However, the process follows a different approach. First, the model used for embedding has provisions to generate vectors that is specific to a task. The embedding model is thus fine-tuned to do eight different tasks that are defined in the previous validation step. Each embedding vector varies slightly or majorly from other if visualized in the lower dimension space. Next, the document is passed through the embedding model to generate a document vector. In essence, a document passes through eight different similarity (or dissimilarity) checks. Alternatively, each task or their combinations can be executed using different machine learning models that are trained using supervised learning methods.

Information Score Evaluation (618): The semantic similarity between the document vector and each of the eight tasks of concept vector is calculated using cosine or any other function. This approach may be considered a ‘reverse information retrieval’ step wherein the concepts classes are searched in the document. In a forward information retrieval, it is usually done the other way round wherein a query (document in this case) is searched for similarity within a corpus (concept definition). The score for each task is aggregated by a simple weighted average function that either rewards or punishes the similarity of the concept to the document. Note that reward is for positive similarities and punitive is for negative similarity tasks. The final score is normalized between 0 and 1, where 0 indicates that the document has no similarity to the concept and higher the score, closer the similarity.

Determine Top ‘K’ Concepts (620): The document vector is compared to each concept vector producing ‘n’ final scores per document, where ‘n’ is the number of pre-defined concepts. The final scores are sorted to determine top ‘K’ concepts that are closest to the document (K is set to 5 initially). The final score along with the concept names and its metadata is published by this unsupervised technique model.

Output Noise Level (624): Ground truth (labeled documents) is used to determine the score threshold or cut-off that produces a balanced precision recall system. To do that, a smaller but stratified set of documents per concept are manually labeled. Three different score thresholds are set using statistical analysis to represent different confidence interval (at 99.5%, 95%, and less than 95%). Highest score from all the concepts is used to tag noise level. If the highest score is lower than 95% confidence interval threshold limit, the document is considered as ‘High’ noise and is flagged as such. Scores that fall between 95% to 99.5% confidence interval threshold limit is considered as ‘Medium’ noise, while score with greater than 99.5% threshold limit is considered as having ‘Low’ noise. A list of concept names and scores (that passes medium level) are tagged to document. A decision aid module helps to determine if the document is to be discarded or moved to next level of denoising based on the noise level.

An example of the process with inputs and outputs are shown below. In some cases that inputs were kept in the Level 0 and 1 and 3 processes above.

Title: By continuing to browse our site, you agree to
our Cookie Policy. For information visit here . . .

| Level | Outcome | Explanation |
|---|---|---|
| 0 | Keep | Does not violate any guardrails. |
| 1 | Keep | Is well-formed. |
| 2 | Keep | Is relevant {Top recommended class is lifestyle (0.40) |
| | | and second one is business news (0.37); both have |
| | | probability greater than cut-off}. |
| 3 | Discard | Has ‘medium’ noise level but no matching concept. |

Title: Copy file link to clipboard Save file to My
Files. By enabling the Turbo Downloader Beta, you
agree to use software that hasn't been tested . . .

| Level | Outcome | Explanation |
|---|---|---|
| 0 | Keep | Does not violate any guardrails. |
| 1 | Keep | Is well-formed. |
| 2 | Keep | Is relevant {Top recommended class is Business |
| | | (0.98) and second is science and tech news (0.01)}. |
| 3 | Keep | Has ‘medium’ noise level and matching concept |
| | | [{Software Testing, 0.70}]. |

### Keyword to Business Category Affinity Score (218, 330)

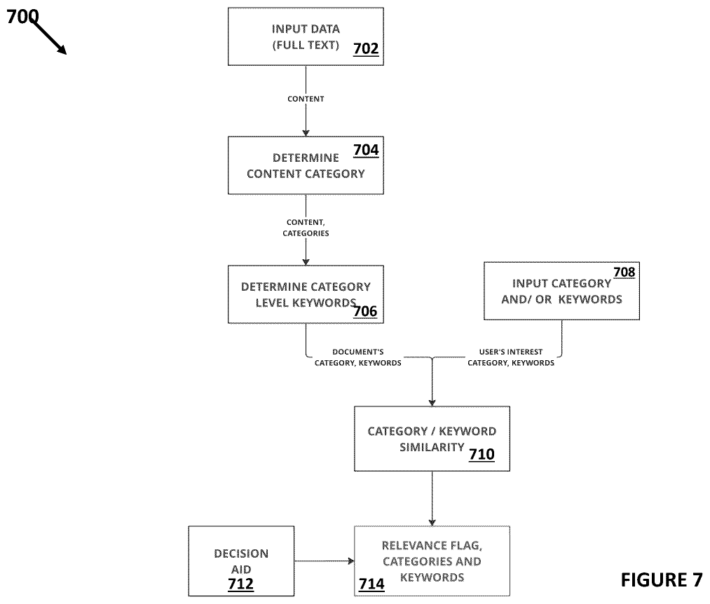

Returning to FIG. 3, the results of the noise level and scoring may be fed into a keyword to topic relevance scoring process (330) that performs its process using model inferences from a topic and keyword model 332. The details of this process are shown in FIG. 7. As discussed above, levels 0, 1, 2 & 3 applies various filters on real-world document content to check for business relevance. In the keyword to business category affinity process 700 shown in FIG. 7, the documents are either discarded at the level or kept and moved to the next level. The next two levels 4 and 5 (334, 340) including the process in FIG. 7, do not discard or reject any document. It evaluates the finer context of the document. Level 4 looks at the topical and keyword context (method 700) to complete the content analysis. Input to this level includes the content, and (optionally), a set of topics and/or keywords.

Determine Content Category (704): The first process receives full text input data (702) and generates business category based on the text content (704). This could be achieved by classification models that is built in a supervised or alternatively, unsupervised model. In this implementation, a supervised model using BERT (google/bert_uncased_L-12_H-768_A-12) as the base pre-trained model is used. The base model is fine-tuned to classify the content into business category most relevant to it. 165 business categories are pre-defined as classes for the fine-tuned model. This is very important step as it forms the basis of extracting keywords that are relevant to the business category instead of generally useful terms. A simple example to illustrate the difference is the usage of keyword ‘artificial intelligence’ in a stock investment article. The term is no doubt important given the current technology trend. However, in a stock market related article, the term may just represent a business domain rather than the technology itself. The importance of this keyword for financial market is lesser than other terms such as ‘stock market’, ‘NASDAQ’ etc. Step 1 discovers the core business categories (top ‘k’) discussed in the content using a multi-label-multi-class classifier model. Alternatively, an unsupervised model or a semi-supervised approach achieves the same result.

Determine Category Level Keyword (706): In this process, category level keywords are extracted and tagged from the document based on the content category. The keyword generation process can be anything, but the underlying algorithm considers the contextual category of the document. The method is usually based on unsupervised learning technique because keywords are open unbounded set of terms.

Request Input Category and Keywords (Optional process 708): This is an optional process in the system wherein the user declares the categories and keywords they are interested in. For consistency, the input category name is a bounded list of 165 business categories and the target application or user need to have sufficient knowledge about the structure and the members of the bounded list to pass the right input to the process. However, the system may be able to map the user's version of the business category with its own category definition automatically to bring in additional flexibility. Keyword on the other hand is an unbounded list and hence the user can enter the data as a list of strings with no restriction except on the number of words per key phrase (usually limited to five). One or both the inputs if provided, sets the context of the content usage. If no such data is provided, the final outcome is still be produced as described below.

Calculate Category-Keyword Similarity (710): The problem solved by this process is, given ‘input category’ and ‘content category’, how close are these? If both the data points use the same structure, taxonomy, and business category names, then a simple match helps. Closeness is inherently defined in the hierarchy. For example, if the two categories are different but have the same parent, the two are closer but not exact matches. Heuristics is defined to quantify the answer as a score. If the format or structure is different and the two do not belong to same taxonomy, a semantic similarity may be determined. The nuanced approach is used that matches name-to-name, or name-to-description depending on whatever input data is available. The latter is more precise and may be used.

A second problem solved is, given ‘input keywords’ and ‘content keywords’, how close are these? Since keyword is always an unbounded list, semantic similarity is used to determine the score. However, just using the keyword-to-keyword pair-wise semantic match results in high score in several cases where it should be low. For example, the keyword bank in ‘consumer bank login’ and ‘consumers bank on expertise of customer care’ are same but not close. The matching algorithm uses the combination of category and keywords where available to generate the best score.

Publish Outcome (714): A ‘keyword to topic relevance flag’ is published as High, Medium, or Low. The flag is determined by combination of proximity scores between input category and content category, and input keyword and content keyword in the context of category. The cut-off score setting for the flags High, Medium, and Low is based on >=99.5%, >=95%, and <95% confidence intervals, respectively as measured on a human annotated ground truth data. Along with the relevance flag, this component produces categories and keywords as metadata that are passed to the next level.

An example of the process 700 with inputs and outputs are shown below. In some cases that inputs in the examples were kept in the Level 0-3 processes above.

Title + Content: Copy file link to clipboard Save
file to My Files. By enabling the Turbo Downloader Beta,
you agree to use software that hasn't been tested . . .
Context: Marketing >> Content Marketing

| Level | Outcome | Explanation |
|---|---|---|
| 0 | Keep | Does not violate any guardrails. |
| 1 | Keep | Is well-formed. |
| 2 | Keep | Is relevant {Top recommended class is Business |
| | | (0.98) and second one is science and tech news |
| | | (0.01)}. |
| 3 | Keep | Has ‘medium’ noise level and matching concept |
| | | [{Software Testing, 0.70}]. |
| 4 | Low | Doc Categories: Product Development & QA |
| | Relevance | Doc Category Keywords: ‘software tested’, ‘file |
| | | link’, ‘turbo downloader’ |

Title + Content: Hospitality crisis management practices:
The case of Indian luxury hotels. This study examines hospitality
crisis management practices within the context of the Indian
hospitality industry. The study is a replication of a study
previously conducted in Israel. The study employs a questionnaire
that evaluates the importance and usage of four themes of practices:
marketing, hotel maintenance, HR, and governmental assistance . . .
Context: Business >> Hospitality Property

| Level | Outcome | Explanation |
|---|---|---|
| 0 | Keep | Does not violate any guardrails. |
| 1 | Keep | Is well-formed. |
| 2 | Keep | Is relevant {Top recommended class is Business (0.98) |
| | | and second one is lifestyle (0.01)}. |
| 3 | Keep | Has ‘low’ noise level and matching concepts [{Disaster |
| | | Management, 0,77}, {Business Continuity, 0.75}, |
| | | {Emergency Management, 0.074}]. |
| 4 | High | Categories: ‘Urban Planning’, ‘Construction’ |
| | Relevance | Keywords for Urban Planning: ‘crisis management’, |
| | | ‘governmental assistance’. |
| | | Keywords for Construction: ‘hotel maintenance’, |
| | | ‘themes practice’. |

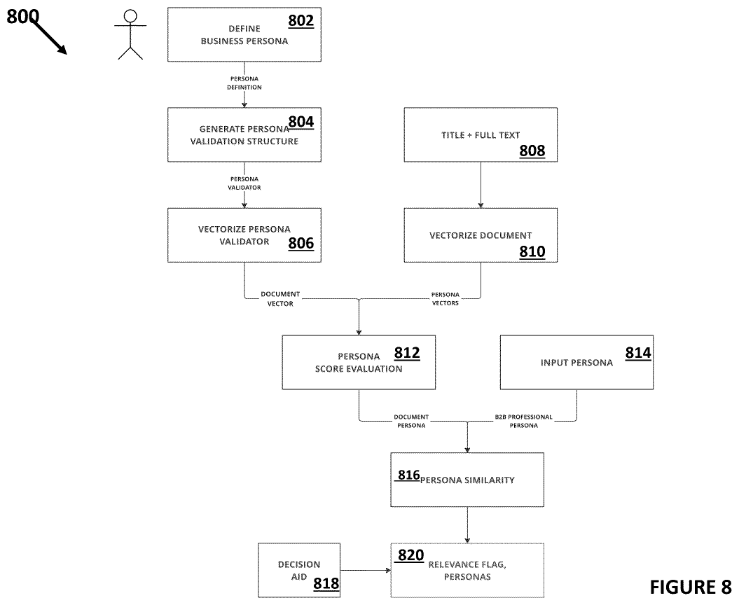

Returning to FIG. 3, the results of the keyword to tops relevance scoring process 330 (and method 700 in FIG. 7) may be fed into a persona relevance scoring process (220 in FIG. 2) 336 that used model inferences from a content-audience relevance model (338). FIG. 8 illustrates more details of the persona relevance process 336, 800. Business personas form the core of level 5. Before the document reaches this point all the harmful, ill-formed, non-business relevant, and high noise contents are already discarded, and only high-quality business contents are being analyzed. Further, the content is associated with a set of business concepts, topics, and keywords as metatags. All the basic checks are also complete. Level 5 just adds another dimension to the content viz., persona. This is a major part of the solution. The objective is not discarding a document, but it is of twofold: (i) identify which persona is best suited to consume the content, and (ii) if the input has a set of personas in some form, the step verifies if the content is relevant to that persona or not (process 340).

The process is very similar to the noise reduction wherein business concepts were defined to identify information/noise components. The equivalent of that in this step is the development and definition of persona. Reversal of ‘information retrieval’ algorithm is implemented that uses attributes of the defined personas and identifies (quantitatively) how much of the persona information is present in the document. As discussed earlier, this technique uses semi-supervised machine learning method with an unsupervised component that quantifies persona information in the input document, while the labeled ground truth supplemented with statistical analysis is used for supervising the right persona for content consumption.

Why Business Persona: There is a dependence on personas in the B2B scenario due to the following reasons: B2B buyers do a lot more due diligence about the products and services making the sales cycle longer; several stakeholders with different roles and responsibilities are involved in decision making process that make the sales cycle complex; demographics and other such individual data about a person are not an indicator of buyer's behavior; there is no direct correlation of the past purchase history by individuals with current or future needs due to group purchasing behavior; and all these make B2B targeting at individual levels quite challenging. A pragmatic solution in this scenario is to identify the buyer's interest (in a content) based on certain higher level of grouping. Attributes such as ‘department’ or ‘job function’ of the buyer is too broad to target, while ‘job titles’ are too specific. Other attributes such as ‘seniority’ helps to a certain extent. Professional interests of the buyer may be derived by examining their ‘skills’ and ‘education’. Putting all these together is a non-trivial task and hence, the invention uses the concept of business persona as a grouping to identify the right target audience.

Define Business Persona (802): Business personas are adopted from the occupation definition in SOC-2020 that is published by government agencies in the United states. Although the occupation data is not exhaustive and is not built for targeting audience in a B2B domain. The method chooses the most relevant occupation list and creates a three-level persona taxonomy. Once the persona names are in place, metadata are generated and associated with it using the source/algorithms that may include one or more of:
Three-level persona definition (SOC-2020 occupation codes).
Typical job description of the persona (SOC-2020 description augmented with the output generated by prompting Large Language Models or LLMs).
Job functions, job areas, and job seniority of the persona (using an in-house solution-patent applied).
Typical job titles of the persona (using an in-house solution-patent applied).
Typical skills of the persona (using an in-house solution-patent applied).

An example of a full persona definition is shown below.
Persona—Accountants and Auditors
Hierarchy—Business and Financial Operations>>Financial Specialists
Description—Prepares and examines financial records, ensuring records are accurate and that taxes are paid properly and on time. Assesses financial operations and work to help ensure that organizations run efficiently. Offers recommendations to businesses and individuals for cost savings, revenue enhancement, and financial management improvement. Conducts audits to ensure compliance with laws and regulations and to identify opportunities for performance improvement. Prepares financial documents, business activity reports, and forecasts.
Has Skills—accounting software and systems, analytical and problem-solving, attention to detail and accuracy, knowledge of financial regulations and legislation, effective communication, and interpersonal skills, business operations and financial processes, advanced excel skills, data analysis.
Works in function—Finance, Accounting, Internal Audit, Financial Reporting, Compliance.
Works in areas of—Financial Reporting, Tax Preparation, Tax Planning, Auditing, Management Accounting, Financial Analysis.
Holds Job Titles—Accountant, Auditor, Staff Accountant, Senior Accountant, Internal Auditor, Certified Public Accountant (CPA), Cost Accountant, Tax Accountant, Forensic Accountant.
Has Job Seniority—Mid-level executive, Senior-level executive.
The business persona may be stored in data library in different formats to support the requirement of different applications.

Generate Persona Validation (804): The persona validation structure for ‘accountant and auditor’ consists of the following six queries asked in a natural language:

```
  {
    description: “What percentage of document tokens or words are found to be
        similar to the {persona description}?”
      skills: “What skills in the document are similar to the {persona skills}?”
      function: “Is there a mention of department in the document? If yes, are the
      departments like the {persona functions}?”
      area: “Is there a mention of any business process in the document? If yes, are
      the processes like the {persona work areas}?”
      titles: “Is there a direct mention of job title in the document? If yes, are those
      titles similar to the {persona titles}?”
      seniority: “Is there a mention of seniority of any person in the document? If yes,
        does the seniority match with {persona seniority}?”
}
```

Vectorize Document and Persona Validator (806, 810): The validator structure provides six different dimensions of analyzing relevance of a document for personas. Each dimension is treated as a task and machine learning models are used to infer the outcome for the task. The approach used in this process is like the one described previously in the noise evaluation process (level 3) above. An embedding model that can be fine-tuned for different tasks is used to produce vectors. For each persona and the task statement is completed by filling in values from the metadata. The validation task is then converted to a vector. Thus, if there are ‘n’ personas, for the six tasks a total of n*6 vectors is produced and stored in a database. The same embedding model is used to vectorize the document as well so that the vectors belong to (and can be visualized) in the same dimensional space. Note that the model approach described above is one of the ways to prepare the persona validator with answers. Other techniques may be used to answer these questions such as using supervised machine learning models, unsupervised methods that queries large language models (LLMs), or any other semi-supervised approach. Also note that the vector storage is not limited to the database type. Any database storage solution including but not limited to vector databases may be used.

Persona Score Evaluation (812): Two sets of vectors are available at this stage. The document vector that is being evaluated and the n*6 persona vectors that form the validation group. Semantic similarity between the doc vector and each of the persona vector is calculated using cosine or any other function. In the reverse information retrieval step, each of the persona definition is searched for similarity within the document to generate a score. The scores from six vectors per persona is aggregated into a single score using simple weighted average method. The net result is ‘n’ scores in the range of 0 to 1 that can be sorted and ranked in preparation for next processes.

Input Persona (814): A branch in the main flow is introduced to provide users with flexibility to input a persona for matching. This is an optional step wherein the user can share their targeted persona. Since the persona a bounded list, the predefined list is assumed to be known to the end user of the system. However, it may be possible that the external systems and users are unaware of this list/taxonomy and may follow their own convention. Such a scenario is likely and resolved in the next process.

Calculate Input to Document Persona Similarity (816): If the end user is internal and follows the predefined persona taxonomy exact match strategy is used to check the input persona with the document persona. Here, the system provides flexibility to match from top ‘k’ persona where k may be determined arbitrarily (say, top 3) or may be derived statistically. If the end user is external and do not follow the internal list, semantic similarity between the input persona and the document persona may be determined. Nuanced approach is used that matches name-to-name, or name-to-description depending on whatever input data is available. The latter is more precise and is used in this process. As before, the match can be made on top ‘k’ personas instead of full list.

Output Relevance Flag (820): The output of this stage can be: (i) top ‘k’ persona tag and score associated with the document, and (ii) a relevance match level ‘low’, ‘medium’, ‘high’ if user input persona is available. The match level is calculated using score threshold or cut-off that produces a balanced precision recall metrics. Ground truth (labeled documents) consisting of a smaller but stratified set of documents per persona is set aside for testing. A decision aid module helps to determine the relevance of the document to the personas.

As before, three different score thresholds are set using statistical analysis to represent different confidence interval (at 99.5%, 95%, and less than 95%). For each of the top ‘k’ persona, the threshold score is calculated to produce output with the above confidence interval. Scores with lower than 95% confidence interval threshold limit indicates ‘Low Relevance’ of the document to the input persona. Similarly, scores between 95% to 99.5% confidence interval and greater than 99.5% confidence interval is considered as ‘Medium Relevance’ and ‘High Relevance’ respectively.

### Summarize Content Noise Components

Returning to FIG. 3, the output from the persona relevance scoring may be red into a summary process 342 in which the flags, scores and metadata are presented to a downstream app 344 along with recommendations with details.

A sample input and output of content noise evaluation system looks like below.

```
{
“input”: [{
    “document url”: “<< document url >>”,
    “document content”: “<< text >>”,
    “input category”: “<< categories of interest >>”,
    “input keyword”: “<< keywords of interest >>”,
    “input persona”: “<< personas of the audience >>”,
      }],
“output”: [{
      “level”: “<< level number >>”,
      “decision”: “<< keep/ discard/ relevance flag >>”,
      “explanation”: “<< explanation of decision strings >>”,
      “metatags”: [{
        “tag name”: “<< guardrail term/ phrase/ b2b class/
          concept name/ noise level/ business
          categories/ keywords/ personas >>”,
        “score”: << probability or score for the tag >>
        }]
      }]
  “final recommendation”: [{ keep/ discard/ relevance flag }]
}
```

FIG. 9 illustrates more details of the guardrail (Level 0) process 208,306 discussed above. This process receives input data (900) that is a title and/or first twenty five words for each piece of content. Using this input data, a LDNOOBW dictionary (904) provides semantic rules to determine if any of the words in the content match words in the LDNOOBW dictionary (902). If there is a match (meaning that the content has a dirty, naughty, obscene or other bad word), then the particular piece of content (a document in this example) is discarded (906) and the discarded content is stored in a capture log with an explanation (908). If there are no word matches to the LDNOOBW dictionary, the process may use gaming and other dictionaries (912) to see if there any word matches (910). If there are word matches to the gaming and other dictionaries, the piece of content is discarded (914) and information about the discarded piece of content is stored in the capture log with an explanation (908). If there are no matches, then the piece of content is kept (916) which is also noted in capture log with an explanation (908). The Level 0 process in FIG. 9 may be performed for each piece of content (a document in one example.)

FIG. 10 illustrates more details of the well formed content detecting (Level 1) process 210, 312 discussed above. This process receives input data (1000) that is a title and/or first twenty five words broken into chunks for each piece of content. Using this input data, NLTK libraries (sentence tokenizer) (1004) may perform sentence/phrase checks to determine if the piece of content is a valid sentence or phrase (1002). If the input is not a valid sentence or phrase, then the particular piece of content (a document in this example) is discarded (1006) and the discarded content is stored in a capture log with an explanation (1008). If the input is a valid sentence/phrase, the process may use custom libraries with semantic rules (1012) to determine if the content has a run-on phrase/SPL, chars etc. and determines if the content passes the custom rules 1010. If the content does not pass the custom rules, the piece of content is discarded (1014) and information about the discarded piece of content is stored in the capture log with an explanation (1008). If the content passes the custom rules, then the piece of content is kept (1016) which is also noted in capture log with an explanation (1008). The Level 1 process in FIG. 10 may be performed for each piece of content (a document in one example.)

### EXAMPLES

The table below summarizes the solution and uses the following keys to understand the outcomes:
Level 0—Guardrail
Level 1—Text Formation
Level 2—B2B Relevance
Level 3—Noise Level
Level 4—Contextual Relevance
Level 5—Persona Relevance

| Input | ^{LEVEL} {Explanation with Metadata} | Level Outcome |
|---|---|---|
| Text: Does your country | ⁰{presence of word ‘porno’} | Level 0: Discard |
| regulation allow you to view | | Level 1: — |
| this porno content . . . | | Level 2: — |
| | | Level 3: — |
| | | Level 4: — |
| | | Level 5: — |
| Text: M-Class (W163) | ¹{jumbled phrases} | Level 0: Keep |
| Produced 1998-2005: ML 230, | | Level 1: Discard |
| ML 320, CDI Jan. 27, 2013, | | Level 2: — |
| Newbie Thread Starter . . . | | Level 3: — |
| | | Level 4: — |
| | | Level 5: — |
| Text: Most of the people tend | ²{Highest score is business (0.95) as it | Level 0: Keep |
| to buy Azure Tower Level 3 - | looks like a Microsoft article, but the key | Level 1: Keep |
| Gamer Walkthroughs online it's | term ‘gamer’ indicates otherwise} | Level 2: Discard |
| much easier and quicker . . . | | Level 3: — |
| | | Level 4: — |
| | | Level 5: — |
| Text: Bed Bath & Beyond | ²{Top recommended class is lifestyle | Level 0: Keep |
| Employee Quits In Style, | (0.98) but second one is business news | Level 1: Keep |
| Blasts Boss On Price Tag . . . | (0.01) that has very low probability} | Level 2: Discard |
| | | Level 3: — |
| | | Level 4: — |
| | | Level 5: — |
| Text: By continuing to browse | ²{Top recommended class is lifestyle | Level 0: Keep |
| our site, you agree to our | (0.40) and second one is business news | Level 1: Keep |
| Cookie Policy. For information | (0.37)} | Level 2: Keep |
| visit here . . . | ³{Has ‘medium’ noise level but no | Level 3: Discard |
| | matching concept} | Level 4: — |
| | | Level 5: — |
| Text: Copy file link to | ²{Top recommended class is Business | Level 0: Keep |
| clipboard Save file to My | (0.98) and second one is science and tech | Level 1: Keep |
| Files. By enabling the Turbo | news (0.01)} | Level 2: Keep |
| Downloader Beta, you agree to | ³{Has ‘medium’ noise level} | Level 3: Keep |
| use software that hasn't been | ³{matching concept ‘Software Testing’ | Level 4: Low |
| tested . . . | (0.70)} | Relevance |
| Context: Marketing >> Content | ⁴{context ‘marketing >> content marketing’ | Level 5: — |
| | has low affinity to category ‘product | |
| | development & qa’; AND low affinity to | |
| | keywords ‘software tested, file link, turbo | |
| | downloader} | |
| Text: Hospitality crisis | ²{Top recommended class is Business | Level 0: Keep |
| management practices: The | (0.98) and second one is lifestyle (0.01)} | Level 1: Keep |
| case of Indian luxury hotels. | ³{Has ‘low’ noise level} | Level 2: Keep |
| This study examines | ³{matching concepts: ‘Disaster | Level 3: Keep |
| hospitality crisis management | Management, 0.77’, ‘Business Continuity, | Level 4: High |
| practices within the context of | 0.75’, ‘Emergency Management, 0.074’} | Relevance |
| the Indian hospitality industry. | ⁴{context ‘business >> hospitality property’ | Level 5: High |
| The study employs a | has medium affinity to concepts} | Relevance |
| questionnaire that evaluates the | ⁴{context ‘business >> hospitality property’ | |
| importance and usage of four | has high affinity to category ‘urban | |
| themes of practices: marketing, | planning’, ‘construction’; AND medium | |
| hotel maintenance, . . . | affinity to keywords ‘crisis management, | |
| Context: Business >> | governmental assistance, hotel | |
| Hospitality Property | maintenance’} | |
| Persona: Senior executive from | ⁵{skills: hospitality management, crisis | |
| hospitality industry | management} | |
| | ⁵{persona: hospitality executive} | |
| | ⁵{department: operations, marketing} | |
| | ⁵{area: strategy management} | |
| | ⁵{titles: hotel operations manager, guest | |
| | relation manager, crisis management | |
| | coordinator} | |
| | ⁵{seniority: mid-senior level executive} | |

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A system, comprising:
a computer system having a processor and a plurality of lines of instructions executed by the processor;
a computing device that interacts with the computer system to submit a query and receive search results from the computer system in response to the query, the search results being curated content having noise filtered out of the search results; and
the computer system being configured to:
receive a plurality of pieces of content based on the query;
perform, using machine learning, gross filtering on each piece of content to detect noise and domain relevance of each piece of content to generate a gross filtering result for each piece of content and discard a particular piece of content that does not pass the gross filtering to produce a reduced number of pieces of content;
perform, using machine learning, fine filtering to detect noise and relevance to a topic or a persona for each piece of content of the reduced number of pieces of content to generate a fine filtering result for each piece of content of the reduced number of pieces of content and discard a particular piece of content that fails to pass the fine filtering to produce a second reduced number of pieces of content; and
analyze each piece of content of the second reduced number of pieces of content including the gross filtering result and the fine filtering result to generate one or more noise related flags for each piece of content of the second reduced number of pieces of content.

2. The system of claim 1, wherein the computer system configured to perform gross filtering is further configured to filter out a piece of content that contains one of misleading information and harmful content, remove a piece of content that is one of grammatically incorrect and poorly structured and discard a piece of content that is not relevant to a domain.

3. The system of claim 2, wherein the computer system configured to perform fine filtering is further configured to generate a noise score for each piece of content in the reduced number of pieces of content, to generate a content relevance score in which the noise in each piece of content in the reduced number of pieces of content is determined based on a context of the piece of content in the reduced number of pieces of content and generate an audience relevance score that identifies a target audience in the domain for each piece of content in the reduced number of pieces of content.

4. The system of claim 3, wherein the one or more noise related flags further comprises a content safe for consumption flag, a well formed content flag, a relevant to domain flag, a noise level flag, a content relevant to query flag and a content relevant to target persona flag.

5. The system of claim 4, wherein the relevant to domain flag is a relevant to business to business (B2B) domain flag.

6. The system of claim 1, wherein the computer system is further configured to segment each piece of content into at least one sentence, segment each sentence into a plurality of tokens, wherein the gross filtering and fine filtering are performed based on the plurality of tokens for each piece of content.

7. The system of claim 1, wherein the machine learning further comprises one or more of a natural language processing process, a statistical analysis process, a sematic analysis process and a machine learning model process.

8. A method, comprising:
receiving, by a computer, a plurality of pieces of content;
performing, using machine learning executed by the computer, gross filtering on each piece of content to detect noise and domain relevance of each piece of content to generate a gross filtering result for each piece of content and discard a particular piece of content that does not pass the gross filtering to produce a reduced number of pieces of content;
performing, using machine learning executed by the computer, fine filtering to detect noise and relevance to a topic or a persona for each piece of content of the reduced number of pieces of content to generate a fine filtering result for each piece of content of the reduced number of pieces of content and discard a particular piece of content that fails to pass the fine filtering to produce a second reduced number of pieces of content; and
analyzing, by the computer, each piece of content of the second reduced number of pieces of content including the gross filtering result and the fine filtering result to generate one or more noise related flags for each piece of content of the second reduced number of pieces of content.

9. The method of claim 8, wherein performing the gross filtering further comprises filtering out a piece of content that contains one of misleading information and harmful content, removing a piece of content that is one of grammatically incorrect and poorly structured and discarding a piece of content that is not relevant to a domain.

10. The method of claim 9, wherein performing the fine filtering further comprises generating a noise score for each piece of content in the reduced number of pieces of content, generating a content relevance score in which the noise in each piece of content in the reduced number of pieces of content is determined based on a context of the piece of content in the reduced number of pieces of content and generating an audience relevance score that identifies a target audience in the domain for each piece of content in the reduced number of pieces of content.

11. The method of claim 10, wherein the one or more noise related flags further comprises a content safe for consumption flag, a well formed content flag, a relevant to domain flag, a noise level flag, a content relevant to query flag and a content relevant to target persona flag.

12. The method of claim 11, wherein the relevant to domain flag is a relevant to business to business (B2B) domain flag.

13. The method of claim 8 further comprising segmenting each piece of content into at least one sentence, segmenting each sentence into a plurality of tokens, wherein the gross filtering and fine filtering are performed based on the plurality of tokens for each piece of content.

14. The method of claim 8, wherein the machine learning further comprises one or more of a natural language processing process, a statistical analysis process, a sematic analysis process and a machine learning model process.

15. The method of claim 8 further comprising submitting, by a computing device, a query so that the received plurality of pieces of content are in response to the query.

16. The method of claim 8 further comprising presenting, to the computing device, the one or more noise related flags.

17. A computer, comprising:
a processor and a plurality of lines of instructions executed by the processor;
the computer being configured to:
receive a plurality of pieces of content;
perform, using machine learning, gross filtering on each piece of content to detect noise and domain relevance of each piece of content to generate a gross filtering result for each piece of content and discard a particular piece of content that does not pass the gross filtering to produce a reduced number of pieces of content;
perform, using machine learning, fine filtering to detect noise and relevance to a topic or a persona for each piece of content of the reduced number of pieces of content to generate a fine filtering result for each piece of content of the reduced number of pieces of content and discard a particular piece of content that fails to pass the fine filtering to produce a second reduced number of pieces of content; and
analyze each piece of content of the second reduced number of pieces of content including the gross filtering result and the fine filtering result to generate one or more noise related flags for each piece of content of the second reduced number of pieces of content.

18. The computer of claim 17, wherein the computer configured to perform gross filtering is further configured to filter out a piece of content that contains one of misleading information and harmful content, remove a piece of content that is one of grammatically incorrect and poorly structured and discard a piece of content that is not relevant to a domain.

19. The computer of claim 18, wherein the computer configured to perform fine filtering is further configured to generate a noise score for each piece of content in the reduced number of pieces of content, to generate a content relevance score in which the noise in each piece of content in the reduced number of pieces of content is determined based on a context of the piece of content in the reduced number of pieces of content and generate au audience relevance score that identified a target audience in the domain for each piece of content in the reduced number of pieces of content.

20. The computer of claim 19, wherein the one or more noise related flags further comprises a content safe for consumption flag, a well formed content flag, a relevant to domain flag, a noise level flag, a content relevant to query flag and a content relevant to target persona flag.

21. The computer of claim 20, wherein the relevant to domain flag is a relevant to business to business (B2B) domain flag.

22. The computer of claim 17, wherein the computer is further configured to segment each piece of content into at least one sentence, segment each sentence into a plurality of tokens, wherein the gross filtering and fine filtering are performed based on the plurality of tokens for each piece of content.

23. The computer of claim 17, wherein the machine learning further comprises the computer configured to perform one or more of a natural language processing process, a statistical analysis process, a sematic analysis process and a machine learning model process.
